(19) United States
(12) Patent Application Publication
(10) Pub. No.: US 2008/0141434 A1
(43) Pub. Date: Jun. 19, 2008

(54) Method for manufacturing evaporative cooling garment

(75) Inventors: Kevin Pringles, Goodyear, AZ (US); Linda Cook, Goodyear, AZ (US)

Correspondence Address: ETHERTON LAW GROUP, LLC, 5555 E. VAN BUREN STREET, SUITE 100, PHOENIX, AZ, 85008, US

(73) Assignee: Hydro Headwear, LLC

(21) Appl. No.: 11/999,119

(22) Filed: Dec. 4, 2007

Related U.S. Application Data
(60) Provisional application No. 60/873,545, filed on Dec. 7, 2006.

(51) Int. Cl. A41B 1/12; A42C 5/00; B32B 37/00; A42B 1/00

(52) U.S. Cl. 2/127; 2/171.2; 2/195.1; 156/145

(57) ABSTRACT

A method for manufacturing an evaporative cooling garment uses discrete units of a liquid-retentive material formed from the liquid-retentive material in its natural state. The discrete units may be pellets, tablets, or liquid-soluble pouches or capsules. In the preferred embodiment granulated water-absorbent polymer crystals are formed into capsules. The capsules are then sealed in one or more chambers in the garment.

### CROSS-REFERENCE TO RELATED APPLICATIONS

This application claims the benefit of co-pending provisional application number 60/873,545 filed Dec. 7, 2006.

### FIELD OF INVENTION

This invention relates generally to a method of manufacturing and assembling evaporative cooling devices. This invention relates particularly to a method for manufacturing manageable, discrete units of a liquid-retentive material which are assembled into an evaporative cooling garment.

### BACKGROUND

The human body's natural defense mechanism to increased body temperature is the evaporative cooling process known as sweating. It is often advantageous to augment that system through artificial means. Physical devices and processes known in the art employ varying levels of ingenuity to harness different methods of cooling the body. Of particular interest, garments such as hats and neckbands have been devised which incorporate a liquid-absorbent polymer. The garment is saturated with water and, as the water evaporates while worn by the user, it increases heat dissipation from the body. The absorbent material can be easily re-saturated with water by simply immersing the garment under the water again.

Conventionally, these garments are made by placing a granulated or powdered liquid-absorbent material in a flexible tube which is integral with or attached to the garment. Unfortunately, granulated and powdered materials can be quite difficult to manipulate and control in a manufacturing environment, because the materials spill and may cause an inhalation exposure risk. Further, extremely slippery conditions are created if such polymers come in contact with water. It would be desirable to provide a method of manufacturing evaporation garments that is easier, cleaner and safer.

Therefore, it is an object of this invention to provide a method for manufacturing an evaporative cooling device. It is a further object to provide a method for assembling an evaporative cooling garment using discrete units of evaporative material that are assembled into the garment.

### SUMMARY OF THE INVENTION

This invention is a method for manufacturing an evaporative cooling garment using discrete units of a liquid-retentive material formed from the liquid-retentive material in its natural state. The discrete units may be pellets, tablets, or liquid-soluble pouches or capsules. In the preferred embodiment granulated water-absorbent polymer crystals are formed into gel capsules. The gel capsules are then sealed in one or more chambers in the garment.

### BRIEF DESCRIPTION OF THE DRAWINGS

FIG. 1 describes one embodiment of the present invention through functional blocks.

FIG. 2 is a perspective view of a hat with a capsule of liquid-retentive material inside a pocket.

FIG. 3 is a perspective view of a tubular sheath with a tablet of liquid-retentive material inside.

FIG. 4 is a perspective view of a tubular sheath with a pouch of liquid-retentive material inside.

FIG. 5 is a perspective view of a hat with multiple pockets containing capsules of liquid-retentive material.

FIG. 6 is a front view of a neckband with multiple pockets containing capsules of liquid-retentive material.

### DETAILED DESCRIPTION OF THE INVENTION

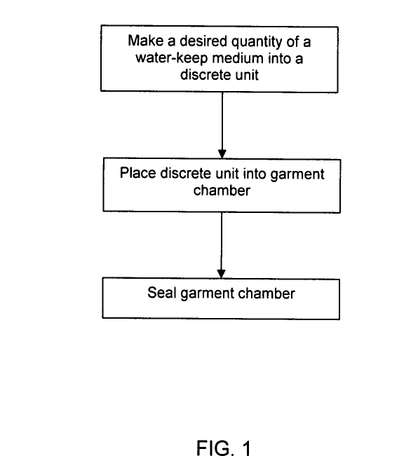

The present novel process is described using a flow diagram as shown in FIG. 1. A quantity of a material that retains liquid, described in more detail below, is made into discrete units from its natural granulated, powdered, or crystalline state. One or more discrete units is placed into one or more chambers of a garment. Each chamber may be integral with the garment or a separate sheath that is attached to the garment. Each chamber is then sealed to prevent the liquid-retentive material from escaping, whether in its dry form or after it has been saturated by a liquid.

The liquid-retentive material is any material capable of retaining liquid and subsequently releasing that liquid through evaporation, causing nearby surfaces to cool. The liquid-retentive material may be absorbent or adsorbent, or both. Preferably it is also non-toxic, inexpensive, and tolerant of many cycles of saturation and evaporation without degradation in structure or performance. In the preferred embodiment, the liquid-retentive material is granulated crosslinked acrylamide-potassium acrylate copolymer, available commercially and referred to as Chemical Abstracts Number 31212-13-2. Another acceptable material is polyacrylimide polymer in crystalline form, Chemical Abstracts Number 71042-87-0. The size of the liquid-retentive material subunits affects how quickly the water is retained in the liquid-retentive material. For example, a volume of small granules will retain water faster than the same volume of medium sized granules. The inventive method may use one uniform size, or vary sizes to efficiently fill a volume. In the preferred embodiment, only medium sized granules are used. In alternative embodiments, small granules or a mixture of medium and small granules are used.

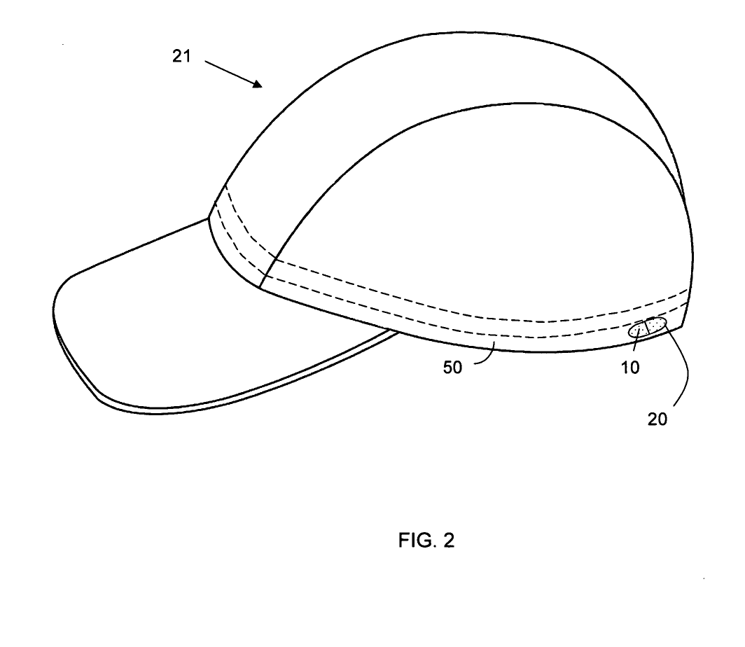

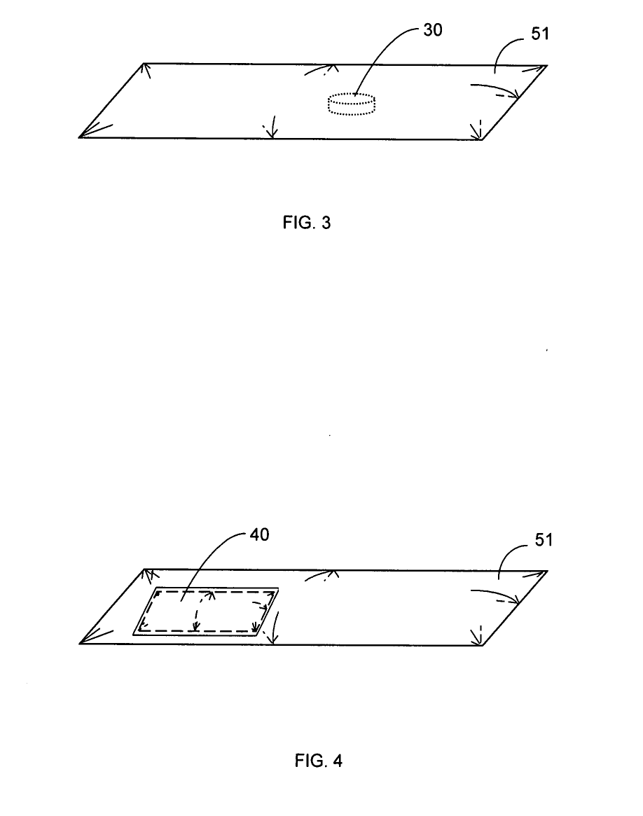

The risks associated with spilling the liquid-retentive material during the manufacturing process are greatly reduced by the present method of forming the liquid-retentive material into discrete units. Due to their size, the discrete units are easier to control while inserting them into chambers in a garment, and do not create inhalation or slipping risks if they are spilled. The discrete unit may be any structure in which the powder, granules, or crystals of liquid-retentive material 10 are held together, such as a capsule, a tablet, a soluble pouch, or a substantially-solid suspension. In the preferred embodiment, illustrated in FIG. 2, a discrete unit is formed by enclosing a quantity of granulated liquid-retentive material 10 in its natural state within a capsule 20. The capsule is sealed and placed within a chamber 50 of the hat 21. The capsule 20 may be any substantially water-soluble material suitable for making capsules. In the preferred embodiment, the capsule 20 is made of hydroxypropyl methylcellulose (“HPMC”), a water-soluble polymer. HPMC capsules are known in the art as “vegetarian” capsules due to the lack of gelatin in the composition. In another embodiment, a quantity of granulated liquid-retentive material 10 is subjected to one or more compression forces, which compact the granulated liquid-retentive material 10 into a substantially solid tablet 30. See FIG. 3. The compression forces can be of any strength and direction sufficient to form a tablet 30 of the desired shape and size, but should not compress the material so far as to prevent dissolution or deformation of the tablet 30 into the liquid-retentive material 10 upon immersion in a target liquid. In another embodiment, a substantially-soluble binder such as a soluble wax, adhesive or gel-like suspension may be applied to the absorbent material to allow formation of the discrete unit. In another embodiment, liquid is added to the liquid-retentive material 10 and the resultant emulsion is molded into discrete units like tablets. Alternatively, the liquid-retentive material can be bound into a single unit which is capable of being separated into multiple discrete units of manageable size. For example, the liquid-retentive material 10 may be extruded or otherwise formed into larger pieces of material that are chopped into smaller pellets. In yet another embodiment, shown in FIG. 4, the granulated or powdered form of the liquid-retentive material 10 is poured into substantially soluble pouches 40.

Capsule filling machines known in the art may be used to create the liquid-retentive material filled capsules 20 of the preferred embodiment. Capsule filling machines may be manually controlled, semi-automatic, or fully automatic. Each machine works in generally the same way. A capsule comprises a cap and a body, the body being longer than the cap. The capsule bodies are placed in an encapsulator, which is a solid block containing rows of round holes which hold the capsule bodies upright with the open end facing up and being either flush with or below the surface of the encapsulator. The user of a manual machine places the capsule bodies in each hole and then pours the material to be inserted into the capsules over the surface of the encapsulator and pushes the material into the capsule bodies with a spreading tool. Then, the caps are pressed onto the bodies, either by hand or with a reciprocal encapsulator that holds the caps in place until the caps and bodies are pressed together. In the preferred embodiment, a semi-automatic filling machine, such as a model available commercially from Capsugel, Peapack N.J., uses a three-stage filling process. First, a user deposits empty capsule bodies into a feeding mechanism, which orients the bodies and distributes them into the encapsulator. Second, the user deposits the granulated polymer into a hopper that distributes the granules into the capsule bodies. Third, the user guides a reciprocal encapsulator to press the caps and bodies together when the capsule bodies are filled. The filling machine is semi-automatic in that manual input is required to move the capsules through the stages.

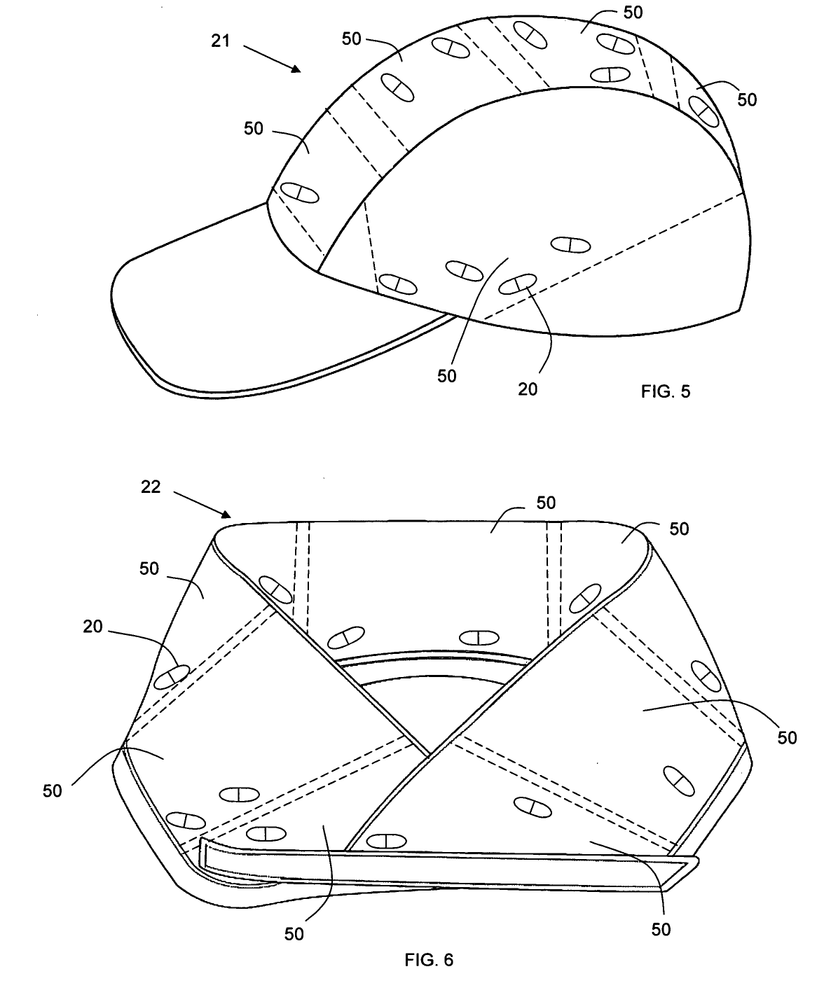

An evaporative cooling garment may comprise one or more chambers designed to contain liquid-retentive material 10. The chambers are preferably comprised of a thin, flexible material through which a target liquid will flow freely but liquid-retentive material cannot escape when wet or dry. A chamber may be integrated into the garment by stitching or other permanent attachment. The dotted lines in FIGS. 2, 5 and 6 indicate stitching that forms chambers. This type of chamber is referred to herein as a pocket 50. FIG. 2 illustrates the preferred embodiment, in which capsules 20 are inserted into a pocket 50 which is created by stitching along the inside of the hat along the hat band, leaving a portion open for insertion of the capsules 20. The open portion is preferably sealed. FIG. 5 illustrates capsules 20 inserted into several pockets 50 integrated into the crown of a hat, and FIG. 6 illustrates capsules 20 inserted into pockets 50 integrated into a neckband. The garment may additionally or alternatively comprise one or more removable chambers, referred to herein as sheaths 51. As shown in FIGS. 3 and 4, a sheath 51 is preferably tube-shaped and detachable from the garment so that it can be separately immersed or used in other garments.

After the discrete units are inserted into the pocket 50 or sheath 51, the pocket 50 or sheath 51 is sealed to prevent the liquid-retentive material 10 from escaping. For a permanent seal, embodiments may utilize a bonding agent or stitch the chamber closed. For a seal that can be re-opened, other embodiments may use a hook and loop seal, such as Velcro®, or tie the opening closed. FIGS. 3 and 4 show the sheath 51 permanently sealed, flattening the ends of the tube somewhat. The flexible tubular sheath 51 is then removably attached to a garment using Velcro® or another nonpermanent attaching means, such that the sheath is held near or in contact with the wearer.

Once inserted, the discrete units may be left intact until the garment is submerged in liquid or they may be dissociated back into the natural state of the liquid-retentive material 10. For example, where the discrete unit is a capsule 20, the capsules 20 may be pulled apart to release the liquid-retentive material 10. Where the discrete unit is a tablet 30, the tablets 30 may be crushed. In the preferred embodiment, the capsules 20 are pulled apart after the chamber is sealed, allowing the polymer granules to disperse into the chamber prior to when the garment is first immersed in liquid.

The garment is then immersed in a target liquid. In the preferred embodiment, the target liquid is water, but in other embodiments it can be any readily-available, non-toxic liquid that evaporates sufficiently in the desired temperature range to cool the garment wearer. If not already dispersed, upon first immersion the discrete units will dissolve, break apart, or otherwise disperse. Then the liquid-retentive material will deform into saturated liquid-retentive material 10 can be positioned anywhere in the chamber. Upon saturation of the liquid-retentive material 10, the apparatus is ready to use. Preferably, the liquid-retentive material 10 will remain in its deformed state after first saturation and will not reform into discrete units.

The present method may be used to manufacture all sorts of garments, including caps, hats, visors, neck bands, vests, shoes, socks, packs, gloves, and wristbands. Preferably the chamber into which the discrete unit is placed is worn on or near part of the wearer's body from which heat is released, such as the head, hands, or feet.

While there has been illustrated and described what is at present considered to be the preferred embodiment of the present invention, it will be understood by those skilled in the art that various changes and modifications may be made and equivalents may be substituted for elements thereof without departing from the true scope of the invention.

I claim:

1. A method for creating an evaporative cooling garment, comprising:
a) forming a liquid-retentive material into a discrete unit; and
b) depositing the discrete unit into a chamber of the garment.

2. The method of claim 1 wherein forming a liquid-retentive material into a discrete unit comprises inserting the liquid-retentive material into a capsule and sealing the capsule.

3. The method of claim 1 wherein the liquid-retentive material is granulated crosslinked acrylamide-potassium acrylate copolymer.

4. The method of claim 1 wherein the liquid-retentive material is polyacrylimide polymer in crystalline form.

5. The method of claim 2 wherein the capsule is a hydroxypropyl methylcellulose capsule.

6. The method of claim 1 wherein forming the liquid-retentive material into a discrete unit comprises applying sufficient force to compact the liquid-retentive material into a tablet.

7. The method of claim 1 wherein forming a liquid-retentive material into a discrete unit comprises applying a bonding agent to the liquid-retentive material.

8. The method of claim 7 wherein the bonding agent is a gel suspension.

9. The method of claim 7 wherein the bonding agent is a wax soluble in a target liquid.

10. The method of claim 9 wherein the target liquid is water.

11. The method of claim 1 further comprising:
a) sealing the chamber; and
b) deforming the discrete unit after sealing the chamber.

12. The method of claim 11 wherein forming the liquid-retentive material into a discrete unit comprises applying sufficient force to compact the liquid-retentive material into a tablet, and deforming the discrete unit comprises crushing the tablet.

13. The method of claim 11 wherein forming a liquid-retentive material into a discrete unit comprises inserting the liquid-retentive material into a capsule and sealing the capsule, and deforming the discrete unit comprises unsealing the capsule.

14. The method of claim 1 wherein the chamber is permanently attached to a garment.

15. The method of claim 1 wherein the chamber is removably attached to a garment.

16. The method of claim 11 further comprising submerging the garment in liquid after deforming the discrete unit.

17. A method for creating an evaporative cooling apparatus, the method comprising:
a) inserting a quantity of granulated crosslinked acrylamide-potassium acrylate copolymer into a hydroxypropyl methylcellulose capsule;
b) sealing the capsule;
c) providing a garment comprising an outer shell and at least one chamber;
d) depositing the capsule into the chamber;
e) sealing the chamber to prevent the granulated crosslinked acrylamide-potassium acrylate copolymer from escaping; and
f) pulling apart the capsule to release the granulated crosslinked acrylamide-potassium acrylate copolymer into the chamber.

18. The method of claim 17 wherein the garment is a hat.

19. The method of claim 17 wherein the garment is a neckband.

20. The method of claim 17 further comprising submerging the garment into a liquid.
